(19) United States
(12) Patent Application Publication
(10) Pub. No.: US 2015/0085870 A1
(43) Pub. Date: Mar. 26, 2015

(54) CO-OPERATIVE LOAD SHARING AND REDUNDANCY IN DISTRIBUTED SERVICE CHAINS IN A NETWORK ENVIRONMENT

(71) Applicant: CISCO TECHNOLOGY, INC., San Jose, CA (US)

(72) Inventors: Maithili Narasimha, Sunnyvale, CA (US); Suraj Nellikar, Santa Clara, CA (US); Sourabh Suresh Patwardhan, Santa Clara, CA (US); Srinivas Sardar, Fremont, CA (US)

(73) Assignee: CISCO TECHNOLOGY, INC., San Jose, CA (US)

(21) Appl. No.: 14/037,210

(22) Filed: Sep. 25, 2013

(51) Int. Cl. H04L 12/931; H04L 12/721

(52) U.S. Cl. CPC H04L 49/70; H04L 45/44
USPC 370/409

(57) ABSTRACT

An example method for co-operative load sharing and redundancy in distributed service chains is provided and includes deriving a service chain comprising a plurality of services in a distributed virtual switch (DVS) network environment, where a first service node provides a first portion of a specific service in the plurality of services to a packet traversing the network, and a second service node provides a second portion of the specific service to the packet, and configuring service forwarding tables at virtual Ethernet Modules associated with respective service nodes in the service chain. In a specific embodiment, the first service node and the second service node provide substantially identical service functions to the packet, wherein the specific service comprises the service functions. In various embodiments, each service node tags each packet to indicate a service completion history of service functions performed on the packet at the service node.

### TECHNICAL FIELD

This disclosure relates in general to the field of communications and, more particularly, to co-operative load sharing and redundancy in distributed service chains in a network environment.

### BACKGROUND

Data centers are increasingly used by enterprises for effective collaboration and interaction and to store data and resources. A typical data center network contains myriad network elements, including hosts, load balancers, routers, switches, etc. The network connecting the network elements provides secure user access to data center services and an infrastructure for deployment, interconnection, and aggregation of shared resource as required, including applications, hosts, appliances, and storage. Improving operational efficiency and optimizing utilization of resources in data centers are some of the challenges facing data center managers. Data center managers want a resilient infrastructure that consistently supports diverse applications and services and protects the applications and services against disruptions. A properly planned and operating data center network provides application and data integrity and optimizes application availability and performance.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a communication system for co-operative load sharing and redundancy in distributed service chains in a network environment;

FIG. 2 is a simplified block diagram illustrating example details of an embodiment of the communication system;

FIG. 3 is a simplified block diagram illustrating yet other example details of an embodiment of the communication system;

FIG. 4 is a simplified block diagram illustrating yet other example details of an embodiment of the communication system;

FIG. 5 is a simplified block diagram illustrating yet other example details of an embodiment of the communication system;

FIG. 6 is a simplified flow diagram illustrating example operations that may be associated with an embodiment of the communication system; and

FIG. 7 is a simplified flow diagram illustrating other example operations that may be associated with an embodiment of the communication system.

### DETAILED DESCRIPTION OF EXAMPLE EMBODIMENTS

### Overview

An example method for co-operative load sharing and redundancy in distributed service chains in a network environment is provided and includes deriving a service chain comprising a plurality of services in a distributed virtual switch (DVS) network environment, where a first service node provides a first portion of a specific service in the plurality of services to a packet traversing the network, and a second service node provides a second portion of the specific service to the packet, and configuring service forwarding tables with the derived service chain at virtual Ethernet Modules (VEMs) associated with the service chain.

### Example Embodiments

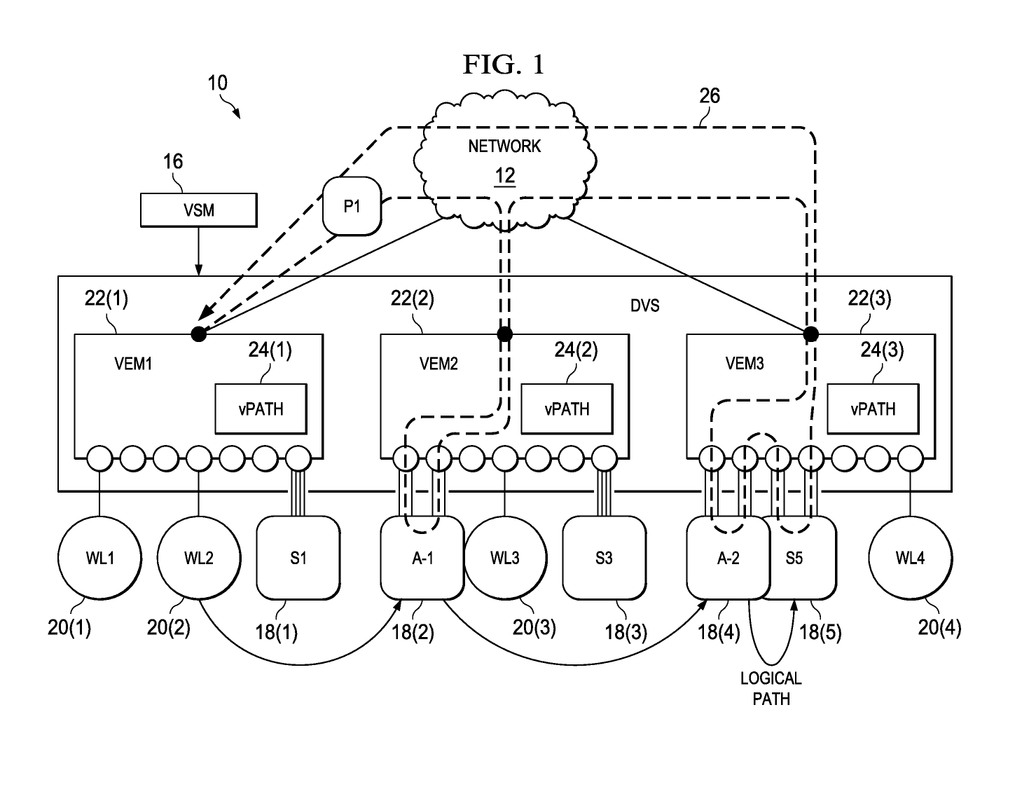

Turning to FIG. 1, FIG. 1 is a simplified block diagram illustrating a communication system 10 for co-operative load sharing and redundancy in distributed service chains in a network environment in accordance with one example embodiment. FIG. 1 illustrates a network 12 (generally indicated by an arrow) comprising a distributed virtual switch (DVS) 14. A virtual supervisor module (VSM) 16 can manage and control DVS 14. A plurality of service nodes (SN) 18(1)-18(5) may provide various network services to packets entering or leaving network 12. A plurality of virtual machines (VMs) may provide respective workloads (WLs) 20(1)-20(5) on DVS 14, for example, by generating or receiving packets through DVS 14. One or more virtual Ethernet modules (VEMs) 22(1)-22(3) may facilitate packet forwarding by DVS 14. In various embodiments, DVS 14 may execute in one or more hypervisors in one or more servers (or other computing and networking devices) in network 12. Each hypervisor may be embedded with one of VEMs 22(1)-22(3) that can perform various data plane functions such as advanced networking and security, switching between directly attached virtual machines, and uplinking to the rest of the network. Each VEM 22(1)-22(3) may include respective vPaths 24(1)-24(3) that can redirect traffic to SNs 18(1)-18(5) before DVS 14 sends the packets appropriately into WLs 20(1)-20(5).

Note that although only a limited number of SNs, WLs, VEMs, and vPaths are provided in the FIGURE for ease of illustration, any number of service nodes, workloads, VEMs and vPaths may be included in communication system 10 within the broad scope of the embodiments. Moreover, the service nodes and workloads may be distributed within network 12 in any suitable configuration, with various VEMs and vPaths to appropriately steer traffic through DVS 14.

VSM 16 can include a process (e.g., instance of a computer program that is executing) that can provision services at one or more service nodes 18(1)-18(5) according to preconfigured settings. The preconfigured settings may be provided at VSM 16 by a user through an appropriate command line interface, graphical user interface, script, or other suitable means. In some embodiments, VSM 16 may comprise a virtual machine executing on a hypervisor with functionalities similar to a supervisor module on a physical switch. The term “VEM” includes one or more network interfaces, at least some portions of switching hardware and associated firmware and software, and one or more processes managing the one or more network interfaces to facilitate packet switching in a switch, including a distributed virtual switch (e.g., DVS 14). The various VMs, including those executing, implementing, or otherwise facilitating SNs 18(1)-18(5) and WLs 20(1)-20(5) may be connected to the VEM (e.g., VEMs 22(1)-22(3)) through virtual Ethernet ports (or other suitable interfaces).

vPath 26(1)-26(3) may facilitate intelligent traffic steering (e.g., redirecting traffic from the server requesting the service to the virtual service node; extending a port profile of an interface to include the network services profile); flexible deployment (e.g., enabling each SN 18(1)-18(5) to serve multiple physical servers, with each SN 18(1)-18(5) being hosted on a dedicated to separate server, if appropriate); and network service acceleration (e.g., using network service decision caching, etc.), among other functionalities.

Service overlay 26 encompasses a level of indirection, or virtualization, allowing a packet (e.g., unit of data communicated in the network) destined to a specific workload to be diverted transparently (e.g., without intervention or knowledge of the workloads) to other service nodes as appropriate. Service overlay 26 includes a logical network built on top of existing network 12 (the underlay). Packets are encapsulated or tunneled to create the overlay network topology. For example, service overlay 26 can include a suitable header (called a network service header (NSH)), with corresponding source and destination addresses relevant to the service nodes in the service chain.

Embodiments of communication system 10 can facilitate co-operative load sharing and redundancy in distributed service chains in a network 12. As used herein, the term “service chain” includes an ordered sequence of a plurality of services provided by one or more SNs (e.g., applications, virtual machines, network appliances, and other network elements that are configured to provide one or more network services) in the network. A “service” may include a feature that performs packet manipulations over and beyond conventional packet forwarding. Examples of services include encryption, decryption, intrusion management, firewall, load balancing, wide area network (WAN) bandwidth optimization, application acceleration, network based application recognition (NBAR), cloud services routing (CSR), virtual interfaces (VIPs), security gateway (SG), network analysis, etc. The service may be considered an optional function performed in a network that provides connectivity to a network user. The same service may be provided by one or more SNs within the network. Each service may comprise one or more “service functions” (e.g., task, such as network address translation (NAT), forwarding (FW), deep packet inspection (DPI), application based packet treatment, etc.; application; compute resource; storage; or content), which singularly or in collaboration with other service functions enable the specific service.

For purposes of illustrating the techniques of communication system 10, it is important to understand the communications that may be traversing the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

Service chaining involves steering traffic through multiple services in a specific order. The traffic may be steered through an overlay network, including an encapsulation of the packet to forward it to appropriate service nodes. Some network architectures, for example that implement advanced vPath capabilities, allow for distributed daisy-chaining of services. The service chains can be of arbitrary length and may comprise various service nodes located on different hosts (e.g., through separate VEMs). The packet processing through the complicated topology of the service nodes in the service chains in such architectures can have a non-trivial impact on end-to-end network throughput. In addition, some service nodes may experience more load than others in the network. As a result, they may slow down the overall speed of packet transmission through the network. In such circumstances (and others), network service providers may desire to bifurcate services into their constituent service functions that are provided at more than one service node; they may also desire redundancy that can be configured into the service chain without too much advanced planning.

Communication system 10 is configured to address these issues (and others) in offering a system and method for co-operative load sharing and redundancy in distributed service chains in a network environment. According to some embodiments, a user (e.g., system administrator) can configure the service chain(s) and provision it directly at applicable workloads (e.g., WL 20(1), 20(2), etc.). VSM 16 may segment the user configured service chains in DVS 14. VSM 16 may derive the service chain (which comprises a plurality of services) from the user's configuration. “Deriving” comprises at least (1) identifying the services to be provided according to the service chain; (2) identifying the service nodes that can provide the services in whole or in part; and (3) dividing the service chain into appropriate segments incorporating the service nodes identified in the previous step (2).

A first service node (e.g., 18(2) A-1) provides a first portion of a specific service (e.g., A) in the plurality of services to a packet traversing network on service overlay 26, and a second service node (e.g., 18(4) A-2) provides a second portion of the specific service (e.g., A) to the packet, and configuring service forwarding tables at VEMs 22(1)-22(3) associated with respective service nodes in the service chain. In a specific embodiment, the first service node (e.g., 18(2) A-1) and the second service node (e.g., 18(4) A-2) provide substantially identical service functions to the packet, where the specific service (e.g., A) comprises the service functions. In various embodiments, each VEM 22(1)-22(3) tags each packet to indicate a service completion history of service functions performed on the packet at respective VEM 22(1)-22(3).

Merely for example purposes and not as a limitation, consider a service chain P1, which may include the following sequence: WL2→A→S5, where A and S5 are services. Assume, merely for example purposes, that service nodes 18(2) (A-1) and 18(4) (A-2) may provide portions of service A, with service node 18(2) performing certain service functions, and service node 18(4) performing certain other service functions, wherein the certain service functions and the certain other service functions together comprise the specific service A. According to various embodiments, VSM 16 may derive the service chain and configure appropriate service forwarding tables (SFTs) at relevant VEMs 22(1)-22(3). In the example of service chain P1, an SFT may be configured at VEM 22(2), indicating that packets on service overlay 26 with service chain identification indicating P1 are to be forwarded to service node 18(2); another SFT may be configured at VEM 22(3), indicating that packets on service overlay 26 with service chain identification indicating P1 are to be forwarded to service nodes 18(4) and 18(5) in that order. Various other information may also be configured in the SFTs, based on particular needs and/or preferences.

According to various embodiments, VEMs 22(1)-22(3) may tag each packet to indicate a service completion history of service functions performed on the packet at respective VEMs 22(1)-22(3). In a specific embodiment, the tagging includes stamping (e.g., setting or resetting a bit, writing, etc.) the service completion history in a service shared context field of the NSH portion of the packet's header. In an example embodiment, the bitmap may indicate that the service is complete (or incomplete). For example, a bit may be set (or reset) to 1 to indicate service completion, and may be set to 0 (or remain unset from its previous value) to indicate that services were not performed at the specific service node. In another example embodiment, the bitmap may indicate the specific sequence of service functions of the specific service that has been completed. Various other possibilities to indicate service history can be included in the NSH within the broad scope of the embodiments.

In another example, consider a service chain configured for a certain tenant in a datacenter network as service chain 1: A→B→C, where A, B and C each represent a specific service. From a network service provider perspective, it may be possible to divide up these independent services (A, B and/or C) into a set of individual co-operating service functions. Assume (merely for example purposes and not as limitations) that each service can be split into two or more service functions. Hence, service chain 1 may be internally represented as: service chain 2: A1→A2→B1→B2→C1→C2. Service chain 2 may be configured or derived at VSM 16 and the corresponding SFT may be programmed at each VEM hosting the service nodes providing service functions A1, A2, B1, B2, C1 and C2, as appropriate. Since A1 and A2 (and B1/B2; C1/C2) are co-operative service functions that together perform the service A (and B; C, respectively), they may communicate partial results or job completion information with each other using the Service Shared Context field of the NSH portion of the packet headers.

In yet another example, a service node may experience high volume of data traffic and may not be able to handle the load on its own. In such scenarios, having a redundant set of service nodes deployed for a specific service can help to mitigate problems such as queue blocking, increase in latency and reduction in throughput. Alternatively, instead of deploying each service node as a redundant high-availability pair (e.g., which can add to the overall complexity of the design and deployment of service nodes), the service provider may opt to simply replicate service nodes and add redundancy to the relevant distributed service chains.

With such enhancement, service chain 2 of the example described previously may be transformed into service chain 3: A1→A2→A2-R→B1→B2→C1→C1-R→C2 wherein A2-R is a redundant service node of A2. The service chain policy administrator (or other relevant user) may determine that service nodes providing service functions A2 and C1 are likely to be overwhelmed, for example, due to execution of processor-intensive tasks. Hence, the service policy administrator may provision redundant service nodes to handle heavy loads. The primary service node (e.g., providing service functions A2) and secondary service node (e.g., providing service function A2-R) and the corresponding VEMs may share information via the service shared context of the NSH portion of the packet header.

The service shared context field of the NSH portion of the packet header can be used to transmit a bitmap indicating service completion. For example, if the service node providing service functions A2 is able to process and finish the task assigned to it, it may set the service completion bit. On the other hand, if the service node providing service functions A2 does not have enough resources to process the task, it may skip the packet and the bit may remain unset. Based on the value of the service completion bit, the redundant service node A2-R may either execute its assigned task (e.g., when the bit is unset) or act as a pass-through (e.g., when the bit is set). In various embodiments, additional information about the service completion may be communicated in other header fields, as appropriate.

According to various embodiments, VSM 16 may divide the services in the distributed service chain into a sequence of service functions that can serve to provide co-operative load sharing and redundancy (e.g., by replicating service nodes instead of deploying complex high availability pairs for service nodes). Additionally, at configuration, the service provider need not worry about optimizing the service chaining path. Service nodes may operate in a co-operative manner to complete the tasks at hand. Service nodes may use specialized tags along with tag rewriting at each node to convey the service functions completed on a packet.

Embodiments of communication system 10 can provide co-operative load sharing among independently deployed service nodes and redundancy in the service path configurations, which can handle high traffic loads and service node failures. Embodiments of communication system 10 can also optimize configuration path for service chains not in use needed. Customers can pick the services desired and VSM 16 can build the SFTs with redundancy incorporated. Run time optimizations can be facilitated by picking the next hop based on the results returned in the relevant tag (e.g., service shared context of NSH).

Turning to the infrastructure of communication system 10, the network topology can include any number of servers, virtual machines, switches (including distributed virtual switches), routers, and other nodes inter-connected to form a large and complex network. A node may be any electronic device, client, server, peer, service, application, or other object capable of sending, receiving, or forwarding information over communications channels in a network. Elements of FIG. 1 may be coupled to one another through one or more interfaces employing any suitable connection (wired or wireless), which provides a viable pathway for electronic communications. Additionally, any one or more of these elements may be combined or removed from the architecture based on particular configuration needs. Communication system 10 may include a configuration capable of TCP/IP communications for the electronic transmission or reception of data packets in a network. Communication system 10 may also operate in conjunction with a User Datagram Protocol/Internet Protocol (UDP/IP) or any other suitable protocol, where appropriate and based on particular needs. In addition, gateways, routers, switches, and any other suitable nodes (physical or virtual) may be used to facilitate electronic communication between various nodes in the network.

Note that the numerical and letter designations assigned to the elements of FIG. 1 do not connote any type of hierarchy; the designations are arbitrary and have been used for purposes of teaching only. Such designations should not be construed in any way to limit their capabilities, functionalities, or applications in the potential environments that may benefit from the features of communication system 10. It should be understood that communication system 10 shown in FIG. 1 is simplified for ease of illustration.

The example network environment may be configured over a physical infrastructure that may include one or more networks and, further, may be configured in any form including, but not limited to, local area networks (LANs), wireless local area networks (WLANs), VLANs, metropolitan area networks (MANs), wide area networks (WANs), VPNs, Intranet, Extranet, any other appropriate architecture or system, or any combination thereof that facilitates communications in a network. In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

In various embodiments, services nodes 18(1)-18(5) represent a specific functionality (e.g., provision of a specific service) and may be embodied in one or more physical appliances. For example, some services nodes (e.g., service nodes 18(4) and 18(5)) may be provided in a common network element, whereas some other service nodes (e.g., 18(1) and 18(2)) may be stand-alone network elements that are configured to exclusively provide the respective specific service. Note that although only five service nodes 18(1)-18(5) are illustrated in FIG. 1, any number of service nodes and corresponding services may be provided within the broad scope of the embodiments.

In various embodiments, workload 20 may be separate computing devices running applications (e.g., server/client applications in client-server network architecture). In other embodiments, workload 20 may be separate virtual machines on the same or different computing devices (e.g., server blades in a data center). In some embodiments, workload 20 may include server blades configured in one or more chassis. DVS 14 may include physical and virtual switches and can include any suitable network element capable of receiving packets, and forwarding packets appropriately in a network environment. Any number of workload may be active within network 12 within the broad scope of the embodiments.

VEMs 20 can include virtual interfaces (e.g., virtual equivalent of physical network access ports) that maintain network configuration attributes, security, and statistics across mobility events, and may be dynamically provisioned within virtualized networks based on network policies stored in DVS 14 as a result of VM provisioning operations by a hypervisor management layer. VEMs 22 may follow virtual network interface cards (vNICs) when VMs move from one physical server to another. The movement can be performed while maintaining port configuration and state, including NetFlow, port statistics, and any Switched Port Analyzer (SPAN) session. Although only three VEMs 22(1)-22(3) and vPaths 24(1)-24(3) are illustrated in FIG. 1, any number of VEMs and vPaths may be provided within the broad scope of the embodiments of communication system 10.

In one example embodiment, VSM 16 may be an application executing with DVS 14. In another embodiment, VSM 16 may be a stand-alone application (e.g., provisioned in a suitable network element) separate and distinct from DVS 14 and communicating therewith through appropriate communication links. In some embodiments, VSM 16 may be provisioned in the same local area network as workload 20. In other embodiments, VSM 16 may be provisioned in a different local area network separate and remote from workload 20. VSM 16 may include a graphical user interface (GUI) based controller, or a CLI based controller, or a combination thereof.

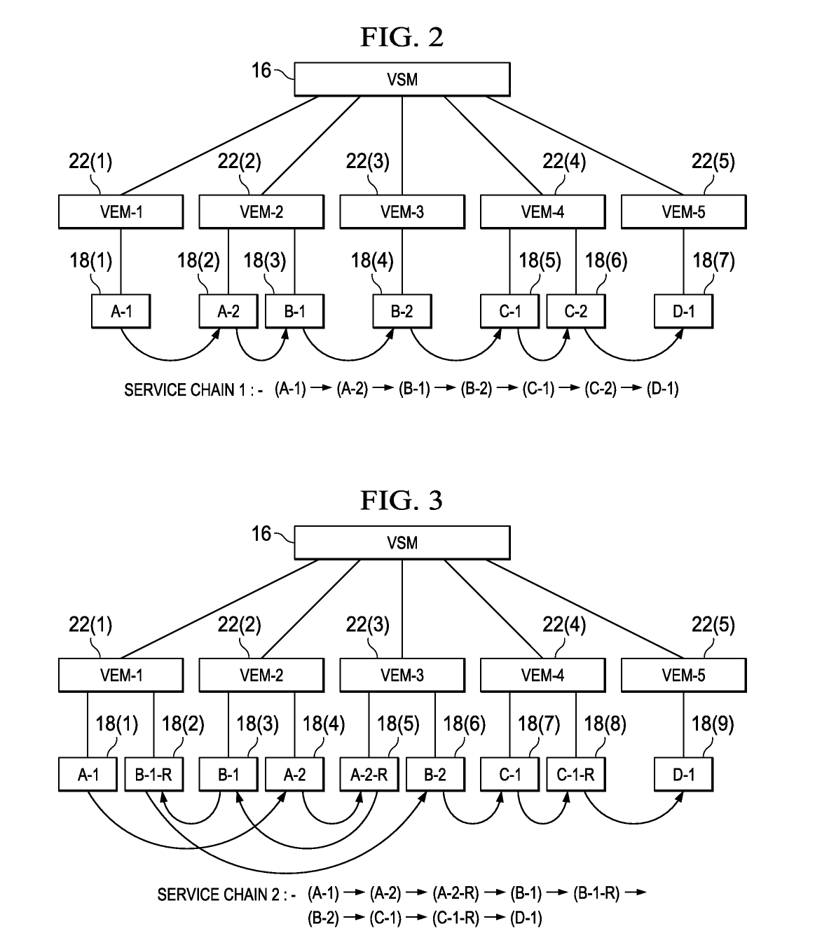

Turning to FIG. 2, FIG. 2 is a simplified block diagram illustrating example details that may be associated with an embodiment of communication system 10. An initial service chain may comprise services A, B, C and D in the following sequence: A→B→C→D. VSM 16 may derive service chain 1 by: identifying the services A, B, C, and D to be provided according to the service chain; identifying the service nodes SN 18(1)-18(7) that can provide the services in whole or in part; and dividing the service chain into appropriate segments (e.g., A-1→A-2→B1→B-2→C-1→C-2→D-1) incorporating the service nodes identified in the previous step. VSM 16 may populate the SFTs appropriately at VEMs 22(1)-22(5) to enable providing services according to service chain 1: A-1→A-2→B1→B-2→C-1→C-2→D-1.

During operation, a packet may be received at SN 18(1) from a WL (not shown). After providing a portion of service A, the packet may be returned to VEM 22(1). A bitmap in an appropriate tag (e.g., service shared context header field of NSH of the packet) may be set (e.g., by SN 18(1)) indicating that certain service functions (e.g., corresponding to A-1) pertaining to service A has been delivered to the packet at SN 18(1). Thereafter, the packet may be forwarded to SN 18(2). VEM 22(2) may inspect the tag and determine that additional service functions pertaining to service A may be delivered to the packet at SN 18(2). The process may continue until all services A, B, C, and D have been provided to the packet as desired.

SNs 18(1) and 18(2) may co-operatively share the load of providing service A by providing service functions A-1 and A-2, respectively. Similarly, SNs 18(3) and 18(4) may co-operatively share the load of providing service B by providing service functions B-1 and B-2, respectively. Likewise, SNs 18(5) and 18(6) may co-operatively share the load of providing service C by providing service functions C-1 and C-2, respectively. SN 18(7) may provide the entire service D at a single service node.

Turning to FIG. 3, FIG. 3 is a simplified block diagram illustrating example details that may be associated with an embodiment of communication system 10. An initial service chain may comprise services A, B, C and D in the following sequence: A→B→C→D. VSM 16 may derive service chain 2 by: identifying the services A, B, C, and D to be provided according to the service chain; identifying the service nodes SN 18(1)-18(9) that can provide the services in whole or in part; and dividing the service chain into appropriate segments (e.g., A-1→A-2→A-2R→B1→B-1-R→B-2→C-1→C-1-R→C-2→D-1) incorporating the service nodes identified in the previous step. VSM 16 may populate the SFTs appropriately at VEMs 22(1)-22(5) to enable providing services according to service chain 2: A-1→A-2→A-2R→B1→B-1-R→B-2→C-1→C-1-R→C-2→D-1.

During operation, a packet may be received at SN 18(1) from a WL (not shown). After providing a portion of service A, the packet may be returned to VEM 22(1). A bitmap in an appropriate tag (e.g., service shared context header field of NSH of the packet) may be set (e.g., by SN 18(1)) indicating that certain service functions (e.g., corresponding to service functions A-1) pertaining to service A has been delivered to the packet at SN 18(1). Thereafter, the packet may be forwarded to SN 18(4). VEM 22(2) may inspect the tag and determine that additional service functions pertaining to service A may be delivered to the packet at SN 18(4). A determination may be made whether SN 18(4) can handle the load of servicing the packet. If SN 18(4) cannot service the packet, the tag may not be set to indicate service completion, and VEM 22(2) may forward the packet to SN 18(5) according to the service chain configured in its SFT. On the other hand, if SN 18(4) can service the packet, the tag may be set to indicate service completion after the service functions have been performed on the packet at SN 18(4), and VEM 22(2) may forward the packet to SN 18(5) according to the service chain configured in its SFT.

VEM 22(3) may inspect the tag of the incoming packet, and determine whether services pertaining to service A has been completed. If the services have been completed, the packet may be forwarded to SN 18(3) according to its SFT. If the services have not been completed, the packet may be forwarded to SN 18(5) to complete the services. The process may continue until all services A, B, C, and D have been provided to the packet as desired.

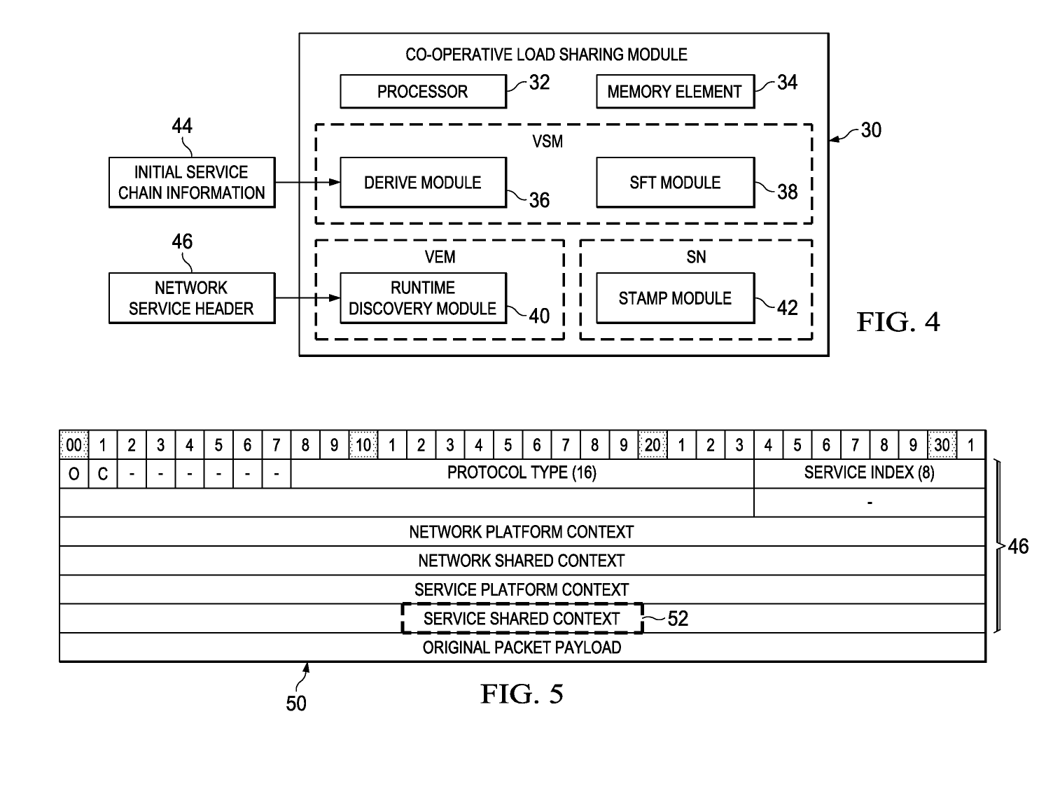

Turning to FIG. 4, FIG. 4 is a simplified block diagram illustrating details of an embodiment of communication system 10. A co-operative load sharing module 30 may include a processor 32, a memory element 34, a derive module 36, a SFT module 38, a runtime discovery module 40, and a stamp module 42. In various embodiments, derive module 36, and SFT module 38 may be provisioned in VSM 16; runtime discovery module 40 may be provisioned in each VEM 22; and stamp module 42 may be provisioned in each SN 18. During service chain configuration, derive module 36 may derive a suitable service chain from an initial service chain information 44 configured by a user (or by other mechanisms) in DVS 14. For example, derive module 36 may identify the services listed in initial service chain configuration, determine the service nodes configured in DVS 14 that can provide the services in whole or in part, and segment the initial service chain into a suitable service chain with co-operative load sharing and redundancy factored into the service chain. SFT module 38 may configure the derived service chain at appropriate VEMs.

During operation, runtime discovery module 40 may inspect a NSH 46 of incoming packets and determine whether the services have been completed as configured according to the derived service chain. If the services have not been completed, the packet may be forwarded to the appropriate service node that can provide the remainder of the services. Otherwise, if the services have been completed, stamp module 42 may stamp the appropriate service history of the packet in a suitable header field. For example, a service shared context field in the NSH may be stamped appropriately (e.g., relevant bit set) to indicate service completion history of the packet. The packet may be forwarded to the next service node that can provide the remaining portion of the service (or next service) in the service chain.

Turning to FIG. 5, FIG. 5 is a simplified block diagram illustrating details of an example packet 50 according to an embodiment of communication system 10. Example packet 50 may include a packet header comprising NSH 46. In addition to path information, NSH 46 also carries metadata used by network elements and/or services. NSH 46 may be added to example packet 60 to create a service plane. Packet 50 including NSH 46 may be encapsulated in an outer header for transport. In various embodiments, NSH 46 may include a 64-bit base header, and four 32-bit context headers. While each context header may include various specific functions, a service shared context 52 in NSH 46 may be used to indicate service completion history of example packet 50. According to various embodiments, VEM 22 may inspect service shared context 52 to determine service completion.

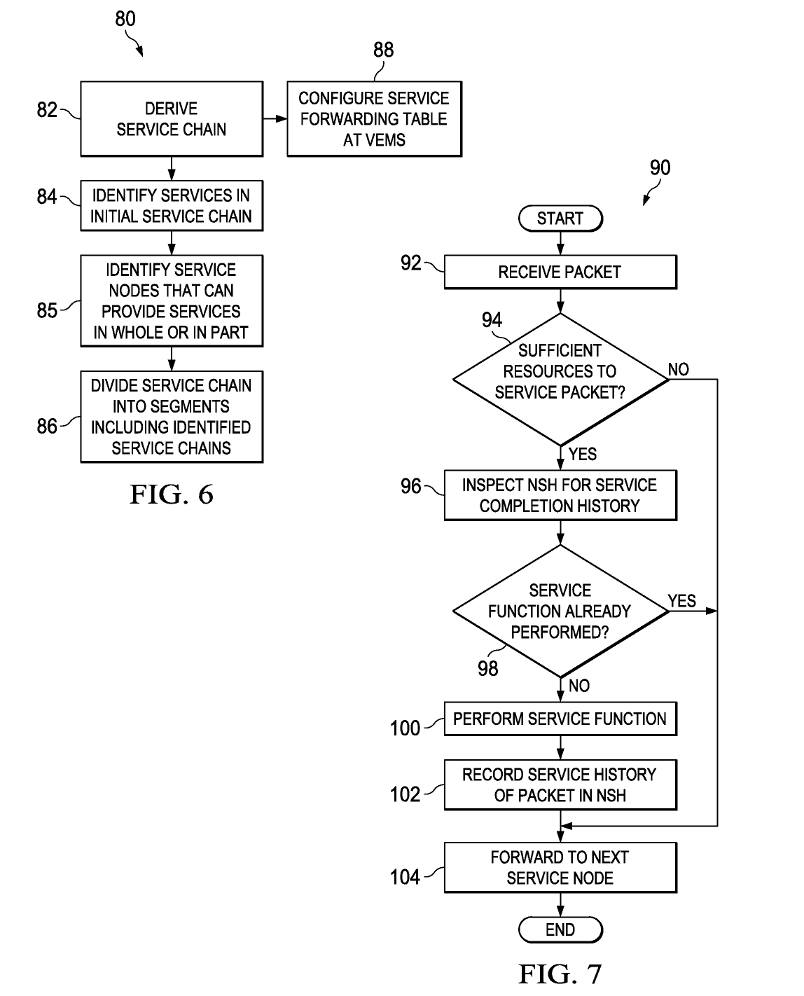

Turning to FIG. 6, FIG. 6 is a simplified flow diagram illustrating example operations 80 that may be associated with example embodiments of communication system 10. At 82, VSM 16 may derive a service chain. Operation 82 may comprise operation 84, at which VSM 16 may identify services in an initial service chain configured by the user (or by other mechanisms) in DVS 14; operation 85, at which VSM 16 may identify service nodes that can provide the services in whole or in part; and operation 86, at which VSM 16 may divide the service chain into segments including the identified service nodes. At 88, VSM 16 may configure SFTs at appropriate VEMs according to the derived service chain.

Turning to FIG. 7, FIG. 7 is a simplified flow diagram illustrating example operations 90 that may be associated with an embodiment of communication system 10. At 92, a VEM may receive a packet. At 94, a determination may be made whether sufficient resources (e.g., processor, memory usage, etc.) are available to service packet at the service node. If sufficient resources are available, at 96, NSH 46 may be inspected for service completion history. At 98, a determination may be made whether the service function has been already performed. If not, at 100, the service function may be performed by the relevant service node. The service history may be recorded in NSH 46 of the packet at 102. At 104, the packet may be forwarded to the next service node in the derived service chain. Turning back to 98, if the service function has been already performed (e.g., as in the case of redundant service nodes), the operations may step to 104. Further, turning back to 94, if resources are insufficient to service the packet, the packet may be forwarded to the next service node at 104.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. Note also that an ‘application’ as used herein this Specification, can be inclusive of an executable file comprising instructions that can be understood and processed on a computer, and may further include library modules loaded during execution, object files, system files, hardware logic, software logic, or any other executable modules. Furthermore, the words “optimize,” “optimization,” and related terms are terms of art that refer to improvements in speed and/or efficiency of a specified outcome and do not purport to indicate that a process for achieving the specified outcome has achieved, or is capable of achieving, an “optimal” or perfectly speedy/perfectly efficient state.

In example implementations, at least some portions of the activities outlined herein may be implemented in software in, for example, DVS 14. In some embodiments, one or more of these features may be implemented in hardware, provided external to these elements, or consolidated in any appropriate manner to achieve the intended functionality. The various network elements (e.g., DVS 14, VSM 16, VEM 22) may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, DVS 14 described and shown herein (and/or their associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory element 34) can store data used for the operations described herein. This includes the memory element being able to store instructions (e.g., software, logic, code, etc.) in non-transitory media, such that the instructions are executed to carry out the activities described in this Specification. A processor can execute any type of instructions associated with the data to achieve the operations detailed herein in this Specification. In one example, processors (e.g., processor 32) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

These devices may further keep information in any suitable type of non-transitory storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in communication system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, communication system 10 may be applicable to other exchanges or routing protocols. Moreover, although communication system 10 has been illustrated with reference to particular elements and operations that facilitate the communication process, these elements, and operations may be replaced by any suitable architecture or process that achieves the intended functionality of communication system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
deriving a service chain that includes a plurality of services in a distributed virtual switch (DVS) network environment, wherein a first service node provides a first portion of a specific service in the plurality of services to a packet traversing the network, and a second service node provides a second portion of the specific service to the packet; and
configuring service forwarding tables with the derived service chain at virtual Ethernet Modules (VEMs) associated with respective service nodes in the service chain.

2. The method of claim 1, wherein the first service node and the second service node provide substantially identical service functions to the packet, wherein the specific service comprises the service functions.

3. The method of claim 2, wherein the second service node provides redundancy to the first service node.

4. The method of claim 1, wherein the deriving comprises:
identifying the services to be provided according to the service chain;
identifying service nodes that can provide the services in whole or in part; and
dividing the service chain into appropriate segments incorporating the service nodes.

5. The method of claim 1, wherein each service node in the service chain tags each packet to indicate a service completion history of service functions performed on the packet at the service node.

6. The method of claim 5, wherein the tagging comprises stamping the service completion history in a service shared context field of a network service header (NSH) portion of the packet's header.

7. The method of claim 6, wherein a bit of the service shared context field may be set to indicate service completion at the respective service node associated with the VEM.

8. The method of claim 7, wherein if the service node skips the packet, the bit remains unset.

9. The method of claim 5, wherein the VEM associated with the second service node inspects the tag on each packet, wherein if the tag indicates that the specific service has not been completed after servicing at the first service node, the packet is forwarded to the second service node to perform the second portion of the specific service.

10. The method of claim 9, wherein if the tag indicates that the specific service has been completed after servicing at the second service node, the second service node is skipped and the packet is forwarded to the next service node in the service chain.

11. Non-transitory tangible media that includes instructions for execution, which when executed by a processor, is operable to perform operations comprising:
deriving a service chain comprising a plurality of services in a DVS network environment, wherein a first service node provides a first portion of a specific service in the plurality of services to a packet traversing the network, and a second service node provides a second portion of the specific service to the packet; and
configuring service forwarding tables with the derived service chain at VEMs associated with respective service nodes in the service chain.

12. The media of claim 11, wherein the first service node and the second service node provide substantially identical service functions to the packet, wherein the specific service comprises the service functions.

13. The media of claim 11, wherein the deriving comprises:
identifying the services to be provided according to the service chain;
identifying service nodes that can provide the services in whole or in part; and
dividing the service chain into appropriate segments incorporating the service nodes.

14. The media of claim 11, wherein each service node in the service chain tags each packet to indicate a service completion history of service functions performed on the packet at the service node.

15. The media of claim 14, wherein the VEM associated with the second service node inspects the tag on each packet, wherein if the tag indicates that the specific service has not been completed after servicing at the first service node, the packet is forwarded to the second service node to perform the second portion of the specific service.

16. An apparatus, comprising:
a co-operative load sharing module in a DVS network environment comprising a memory element for storing data and a processor, wherein the processor executes instructions associated with the data, wherein the processor and the memory element cooperate, such that the apparatus is configured for:
deriving a service chain comprising a plurality of services in the DVS network environment, wherein a first service node provides a first portion of a specific service in the plurality of services to a packet traversing the network, and a second service node provides a second portion of the specific service to the packet; and
configuring service forwarding tables with the derived service chain at VEMs associated with respective service nodes in the service chain.

17. The apparatus of claim 16, wherein the first service node and the second service node provide substantially identical service functions to the packet, wherein the specific service comprises the service functions.

18. The apparatus of claim 16, wherein the deriving comprises:
identifying the services to be provided according to the service chain;
identifying service nodes that can provide the services in whole or in part; and
dividing the service chain into appropriate segments incorporating the service nodes.

19. The apparatus of claim 16, wherein each service node in the service chain tags each packet to indicate a service completion history of service functions performed on the packet at the service node.

20. The apparatus of claim 19, wherein the VEM associated with the second service node inspects the tag on each packet, wherein if the tag indicates that the specific service has not been completed after servicing at the first service node, the packet is forwarded to the second service node to perform the second portion of the specific service.
